(19) United States
(12) Patent Application Publication
(10) Pub. No.: US 2025/0029201 A1
(43) Pub. Date: Jan. 23, 2025

(54) IMAGE PROCESSING SUPPORT DEVICE, IMAGE PROCESSING SUPPORT METHOD, AND COMPUTER READABLE MEDIUM

(71) Applicant: Mitsubishi Electric Corporation, Tokyo (JP)

(72) Inventor: Masahiro DEGUCHI, Tokyo (JP)

(73) Assignee: Mitsubishi Electric Corporation, Tokyo (JP)

(21) Appl. No.: 18/909,434

(22) Filed: Oct. 8, 2024

Related U.S. Application Data
(63) Continuation of application No. PCT/JP2022/020475, filed on May 17, 2022.

(51) Int. Cl. G06T 1/20

(52) U.S. Cl. CPC G06T 1/20

(57) ABSTRACT

An engine characteristic acquisition unit (22) acquires an engine characteristic indicating calculation information with a calculation formula by taking information on image data of a processing target as an input, with respect to each of one or more types of engines that can be used in a target image process among engines corresponding to each of a plurality of types of processors. An apparatus characteristic acquisition unit (23) acquires an apparatus characteristic indicating a correction content for the calculation formula indicated by the engine characteristic with respect to one or more types of processors included in a target apparatus among the plurality of types of processors. In a case in which a designated process being an image process designated is performed by a designated apparatus being an apparatus designated, a calculation unit (21) calculates calculation information based on an engine characteristic and an apparatus characteristic with respect to an engine being a calculation target, by taking each of one or more engines that can be used in the designated process, and that are included in the designated apparatus, as the engine being the calculation target.

### CROSS REFERENCE TO RELATED APPLICATION

This application is a Continuation of PCT International Application No. PCT/JP2022/020475, filed on May 17, 2022, which is hereby expressly incorporated by reference into the present application.

### TECHNICAL FIELD

The present disclosure relates to a technique to support selection of an engine to perform image processing.

### BACKGROUND ART

Patent Literature 1 discloses an image processing device to effectively perform image processing using an arithmetic unit. In Patent Literature 1, a processing procedure of image processing, an expected used memory amount and an expected processing time are determined for each parameter set fixedly. The parameter is information fixed depending on the arithmetic unit such as an execution unit of arithmetic processing and a transfer unit of image data.

### CITATION LIST

### Patent Literature

Patent Literature 1: JP2015-18363 A

### SUMMARY OF INVENTION

### Technical Problem

In Patent Literature 1, a processing procedure of image processing, an expected used memory amount and an expected processing time are determined for each parameter set fixedly. Therefore, it is impossible to calculate the used memory amount and the processing time flexibly in accordance with various types of image processing desired by a user. Further, the number of parameters is increased when it is attempted to handle arithmetic units mounted on various apparatuses.

The present disclosure is aimed at making it possible to calculate at least either of the used memory amount and the processing time flexibly corresponding to various types of image processing desired by a user without managing a large amount of information.

### Solution to Problem

An image processing support device according to the present disclosure includes
an engine characteristic acquisition unit to acquire, by taking each of a plurality of image processes as a target image process, an engine characteristic indicating a calculation formula to calculate calculation information being at least either of a used memory amount and a processing time in a case in which the target image process is performed with respect to each of one or more engines that can be used in the target image process among one or more engines corresponding to each of a plurality of types of processors, the calculation formula using information on image data being a processing target as an input,
an apparatus characteristic acquisition unit to acquire, by taking each of a plurality of apparatuses as a target apparatus, apparatus characteristic information indicating a correction content for the calculation formula indicated by the engine characteristic with respect to one or more types of processors that are included in the target apparatus among the plurality of types of processors, and
a calculation unit to calculate the calculation information in a case in which a designated process being an image process designated among the plurality of image processes is performed by a designated apparatus being an apparatus designated among the plurality of apparatuses, by taking each of one or more engines that can be used in the designated process, and corresponds to a processor included in the designated apparatus as an engine being a calculation target, based on the engine characteristic and the apparatus characteristic information with respect to the engine being the calculation target.

### Advantageous Effects of Invention

In the present disclosure, calculation information is calculated based on an engine characteristic of an engine being a target of calculation and an apparatus characteristic. The calculation information is at least either of a used memory amount and a processing time. In this manner, it is possible to make it possible to calculate at least either of the used memory amount and the processing time flexibly corresponding to various types of image processing desired by a user without managing a large amount of information.

### BRIEF DESCRIPTION OF DRAWINGS

FIG. 1 is a configuration diagram of an image processing support device 10 according to a first embodiment;

FIG. 2 is an explanatory diagram of information stored in a module storage unit 31 according to the first embodiment;

FIG. 3 is an explanatory drawing of an image processing module 311 according to the first embodiment;

FIG. 4 is an explanatory drawing of a parameter 313 according to the first embodiment;

FIG. 5 is a diagram illustrating an example of an engine characteristic CPU 314A according to the first embodiment:

FIG. 6 is a diagram illustrating an example of an engine characteristic GPU 314B according to the first embodiment;

FIG. 7 is a diagram illustrating an example of an engine characteristic FPGA 314C according to the first embodiment;

FIG. 8 is an explanatory drawing of information stored in an apparatus characteristic storage unit 32 according to the first embodiment;

FIG. 9 is an explanatory drawing of an apparatus characteristic 321 according to the first embodiment;

FIG. 10 is a diagram illustrating an example of an apparatus characteristic common 322X according to the first embodiment;

FIG. 11 is a diagram illustrating an example of an apparatus characteristic CPU 322A according to the first embodiment;

FIG. 12 is a diagram illustrating an example of an apparatus characteristic GPU 322B according to the first embodiment;

FIG. 13 is a diagram illustrating an example of an apparatus characteristic FPGA 322C according to the first embodiment;

FIG. 14 is a diagram illustrating an example of a hardware configuration of an apparatus 50 according to the first embodiment;

FIG. 15 is a diagram illustrating an example of a hardware configuration of an apparatus 50 according to the first embodiment;

FIG. 16 is a diagram illustrating an example of a hardware configuration of an apparatus 50 according to the first embodiment;

FIG. 17 is a diagram illustrating an example of a hardware configuration of an apparatus 50 according to the first embodiment;

FIG. 18 is a flowchart illustrating a flow of processing of the image processing support device 10 according to the first embodiment;

FIG. 19 is an explanatory drawing of an execution order of image processing according to a second variation;

FIG. 20 is a configuration diagram of the image processing support device 10 according to a third variation;

FIG. 21 is an explanatory drawing of an image processing module 311 of each image processing according to a second embodiment; and

FIG. 22 is an explanatory drawing of a pattern according to the second embodiment.

### DESCRIPTION OF EMBODIMENTS

### First Embodiment

### ***Description of Configuration***

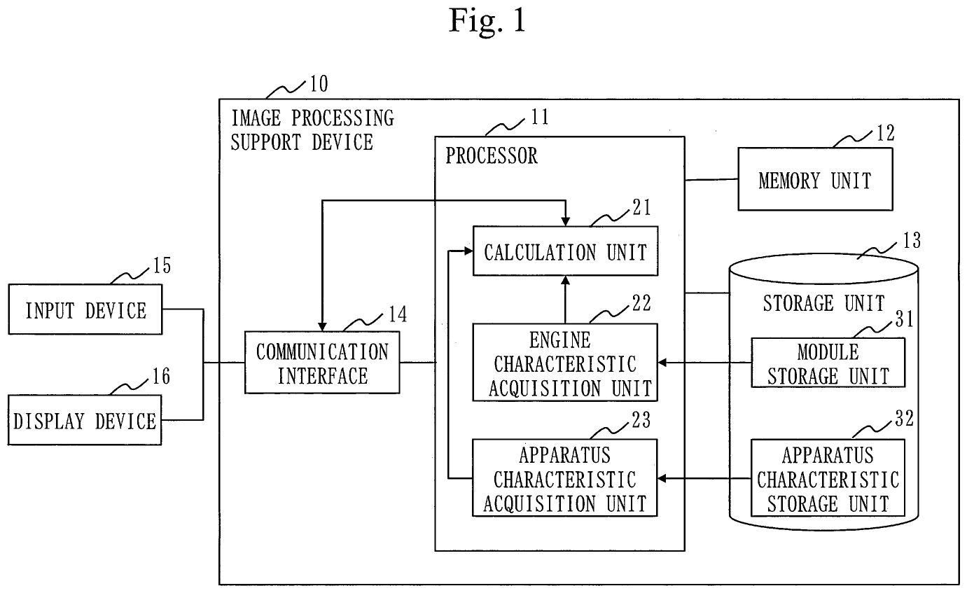

Description will be made on a configuration of an image processing support device 10 according to a first embodiment with reference to FIG. 1.

The image processing support device 10 is a computer.

The image processing support device 10 includes hardware components of a processor 11, a memory unit 12, a storage unit 13 and a communication interface 14. The processor 11 is connected to the other hardware components via signal lines, and controls these other hardware components.

The processor 11 is an IC to perform processing. IC is an abbreviation for Integrated Circuit. The processor 11 is, for example, a CPU. CPU is an abbreviation for Central Processing Unit.

The memory unit 12 is a storage device to temporarily store data. The memory unit 12 is, for example, an SRAM or a DRAM. SRAM is an abbreviation for Static Random Access Memory. DRAM is an abbreviation for Dynamic Random Access Memory.

The storage unit 13 is a storage device to store data. The storage unit 13 is, for example, an HDD. HDD is an abbreviation for Hard Disk Drive. Further, the storage unit 13 may be a portable recording medium such as an SD (registered trademark) memory card, a CompactFlash (registered trademark), a NAND Flash memory, a flexible disk, an optical disk, a compact disk, a Blue-ray (registered trademark) disk, a DVD or the like. SD is an abbreviation for Secure Digital. DVD is an abbreviation for Digital Versatile Disk.

The communication interface 14 is an interface to communicate with an external device. The communication interface 14 is, for example, a port of an Ethernet (registered trademark), a USB or an HDMI (registered trademark). USB is an abbreviation for Universal Serial Bus. HDMI is an abbreviation for High-Definition Multimedia Interface.

The image processing support device 10 is connected to an input device 15 and a display device 16 via the communication interface 14.

The image processing support device 10 includes a calculation unit 21, an engine characteristic acquisition unit 22 and an apparatus characteristic acquisition unit 23, as functional components. The functions of each functional component of the image processing support device 10 are realized by software.

The storage unit 13 stores programs to realize the functions of each functional component of the image processing support device 10. These programs are read into the memory unit 12 by the processor 11, and executed by the processor 11. In this manner, the functions of each functional component of the image processing support device 10 are realized.

The storage unit 13 realizes a module storage unit 31 and an apparatus characteristic storage unit 32.

In FIG. 1, only one processor 11 is illustrated. However, there may be a plurality of processors 11, and the plurality of processors 11 may execute the programs to realize each function in cooperation with one another.

### ***Description of Operation***

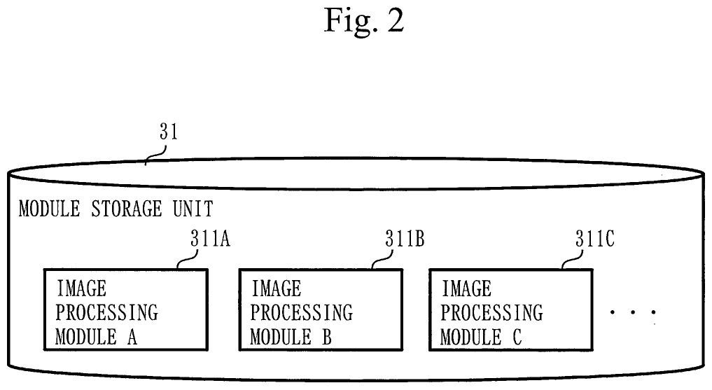

Description will be made on an operation of the image processing support device 10 according to First Embodiment with reference to FIG. 2 through FIG. 18.

The operation procedure of the image processing support device 10 according to First Embodiment corresponds to an image processing support method according to First Embodiment. Further, the programs to realize the operation of the image processing support device 10 according to First Embodiment correspond to an image processing support program according to First Embodiment.

First, information to be stored in the module storage unit 31 and the apparatus characteristic storage unit 32 will be described. In addition, a flow of the processing of the image processing support device 10 will be described.

Description will be made on the information stored in the module storage unit 31 according to First Embodiment with reference to FIG. 2.

The module storage unit 31 stores an image processing module 311 for each of a plurality of sets of image processing.

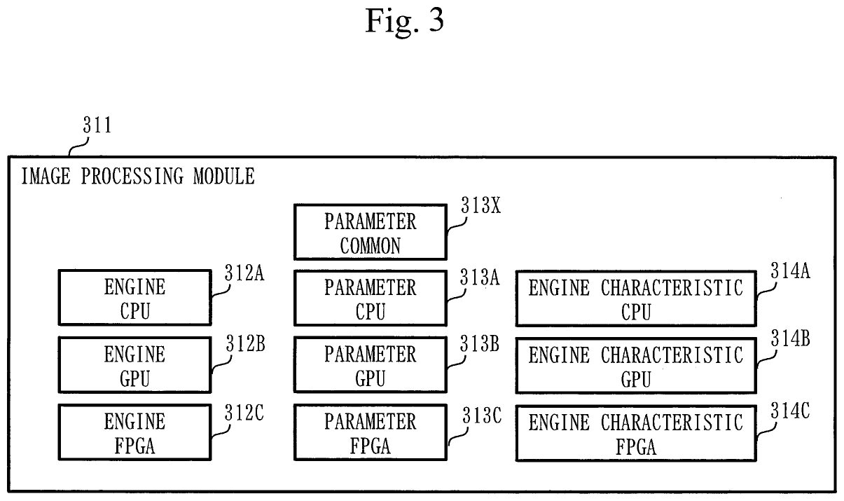

Description will be made on the image processing module 311 according to First Embodiment with reference to FIG. 3.

The image processing module 311 includes an engine 312, a parameter 313 and an engine characteristic 314 for each type of processors. The engine 312 is a program to perform image processing. The parameter 313 indicates a restriction related to the engine 312. The engine characteristic 314 indicates a calculation formula to calculate calculation information being at least either of the used memory amount and the processing time in a case of performing image processing. The engine characteristic 314 indicates a calculation formula with information on image data being the processing target as an input.

In FIG. 3, an engine CPU 312A for CPU, an engine GPU 312B for GPU and an engine FPGA 312C for FPGA are indicated as the engine 312. GPU is an abbreviation for Graphics Processing Unit. FPGA is an abbreviation for Field-Programmable Gate Array.

As the parameter 313, a parameter common 313X common to a CPU, a GPU and an FPGA, a parameter CPU 313A for CPU, a parameter GPU 313B for GPU, and a parameter FPGA 313C for FPGA are indicated.

As the engine characteristic 314, an engine characteristic CPU 314A for CPU, an engine characteristic GPU 314B for GPU and an engine characteristic FPGA 314C for FPGA are indicated.

The engine 312 that can be used differs depending on the image processing module 311. For example, there is a case in which the engine 312 that can be used is only the GPU 312B depending on the image processing module 311. In this case, the image processing module 311 includes only the engine GPU 312B for GPU as the engine 312.

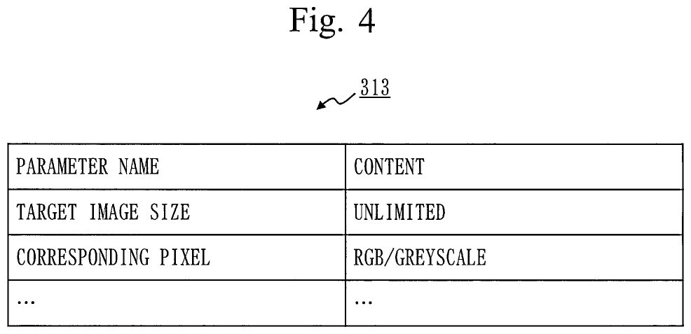

Description will be made on the parameter 313 according to First Embodiment with reference to FIG. 4.

In the parameter 313, contents of restriction are set for each parameter name indicating an item to which a restriction is set.

In FIG. 4, an example of the parameter common 313X is indicated. In FIG. 4, “unrestricted” is indicated for an item of a size of a target image. Further, “RGB or Gray Scale” is indicated for an item of a corresponding pixel. RGB is an abbreviation for Red-Green-Blue color model.

Information is set in similar formats also for the parameter CPU 313A, the parameter GPU 313B and the parameter FPGA 313C.

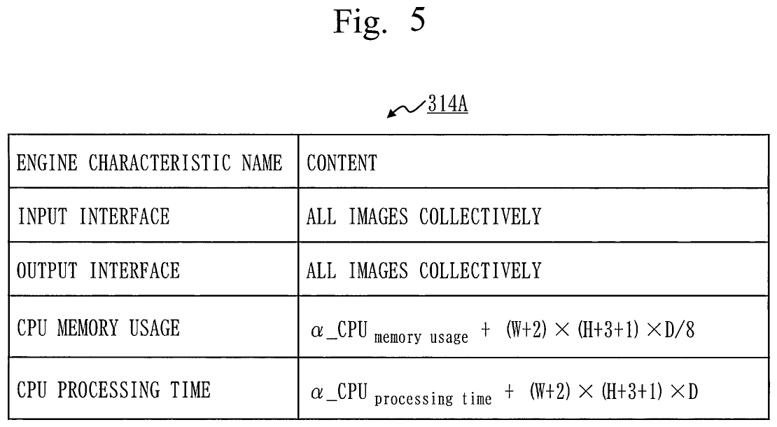

Description will be made on the engine characteristic 314 according to First Embodiment with reference to FIG. 5 through FIG. 7.

FIG. 5 indicates an example of the engine characteristic CPU 314A. For the engine characteristic CPU 314A, a content is set for each engine characteristic name. In FIG. 5, as the engine characteristic name, an input interface, an output interface, a CPU memory usage, a CPU processing time are set.

For the input interface, it is indicated that all images are input collectively. For the output interface, it is indicated that all images are output collectively.

For the CPU memory usage, a calculation formula of a used amount of memory by the CPU is indicated. Specifically, it is indicated that the used memory amount by the CPU is the sum of α_CPU_{memory usage} and (W+2)×(H+3+1)×(D/8). α_CPU_{memory usage} is a basic used amount of memory by a CPU. The basic used amount of memory by the CPU is, for example, a used memory amount that becomes necessary in activating the CPU by an OS, and a used memory amount for managing an engine. OS is an abbreviation for Operating System. α_CPU_{memory usage} is mathematized according to measurement or the like in preparation of the engine. W is a width of the image data being the target of processing. H is a height of the image data being the target of processing. D is the number of bits per pixel constituting the image data being the target of processing.

For the CPU processing time, a calculation formula of the processing time by the CPU is indicated. Specifically, it is indicated that the processing time by the CPU is the sum of α_CPU_{processing time} and (W+2)×(H+3+1)×D. α_CPU_{processing time} is a CPU processing time which is fixed for an engine. The CPU processing time fixed for the engine is, for example, an interruption response time of the OS and a variable initialization time of the engine. α_CPU_{processing time} is mathematized according to measurement or the like in preparation of the engine. W, H and D are as described above.

In First Embodiment, the processing time is not an absolute time of second etc., but a relative time based on a standard prescribed separately.

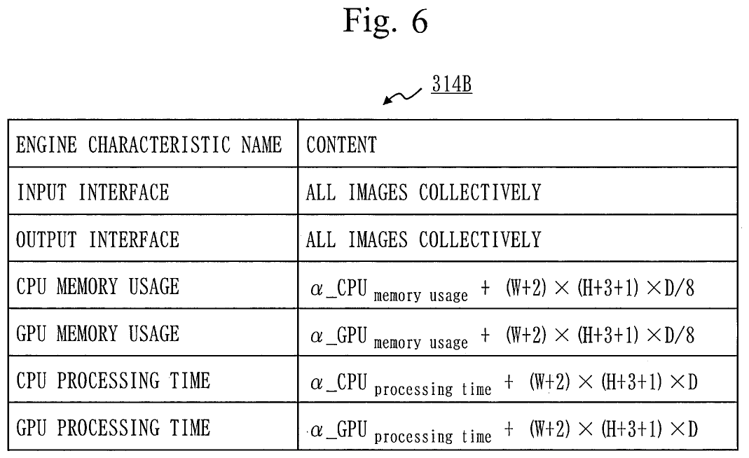

FIG. 6 illustrates an example of the engine characteristic GPU 314B. In the engine characteristic GPU 314B, a content is set for each engine characteristic name. In FIG. 6, as the engine characteristic name, an input interface, an output interface, a CPU memory usage, a GPU memory usage, a CPU processing time and a GPU processing time are set. Even in a case of using the GPU, processing of the CPU occurs. Therefore, the CPU memory usage and the CPU processing time are set.

For the input interface, the output interface, the CPU memory usage and the CPU processing time, the same information as in FIG. 5 is indicated,

For the GPU memory usage, a calculation formula of the processing time by the GPU is indicated. Specifically, it is indicated that the GPU memory usage is the sum of α_GPU_{memory usage} and (W+2)×(H+3+1)×(D/8). α_GPU_{memory usage} is a basic used amount of memory by the GPU. The basic used memory amount by the GPU is, for example, a used memory amount to become necessary in activating the GPU by the OS, and a used memory amount for managing the engine. α_GPU_{memory usage} is mathematized according to measurement or the like in preparation of the engine. W, H and D are as described above.

For the GPU processing time, a calculation formula of the processing time by the GPU is indicated. Specifically, it is indicated that the processing time by the GPU is the sum of α_GPU_{processing time} and (W+2)×(H+3+1)×D. α_GPU_{processing time} is a GPU processing time which is fixed for the engine. The GPU processing time fixed for the engine is, for example, an interruption response time of the OS and a variable initialization time of the engine. α_GPU_{processing time} is mathematized according to measurement or the like in preparation of the engine. W, H and D are as described above.

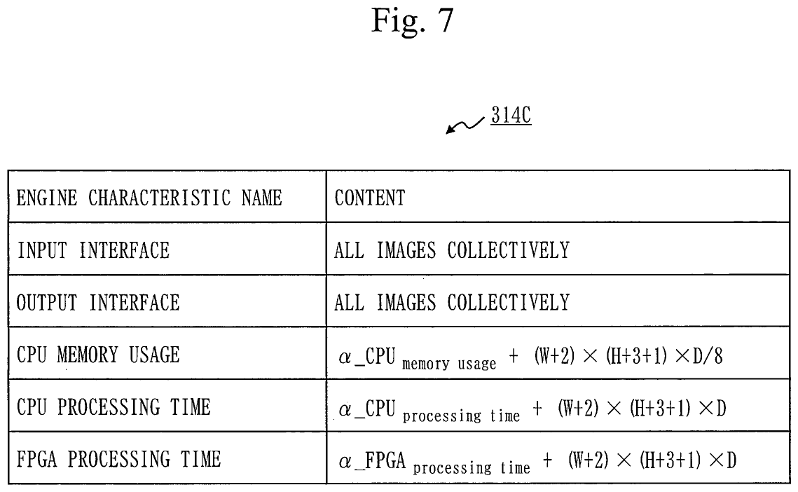

FIG. 7 illustrates an example of the engine characteristic FPGA 314C. In the engine characteristic FPGA 314C, a content is set for each engine characteristic name. In FIG. 7, as the engine characteristic name, an input interface, an output interface, a CPU memory usage, a CPU processing time and an FPGA processing time are set. Even in a case of using the FPGA, processing of the CPU occurs. Therefore, the CPU memory usage and the CPU processing time are set.

For the input interface, the output interface, the CPU memory usage and the CPU processing time, the same information as in FIG. 5 is indicated.

For the FPGA processing time, a calculation formula of the processing time by the FPGA is indicated. Specifically, it is indicated that the processing time by the FPGA is the sum of α_FPGA_{processing time} and (W+2)×(H+3+1)×D. α_FPGA_{processing time} is the CPU processing time which is fixed for the engine. The FPGA processing time fixed for the engine is, for example, an interruption response time of the OS and a variable initialization time of the engine. α_FPGA_{processing time} is mathematized according to measurement or the like in preparation of the engine. W, H and D are as described above.

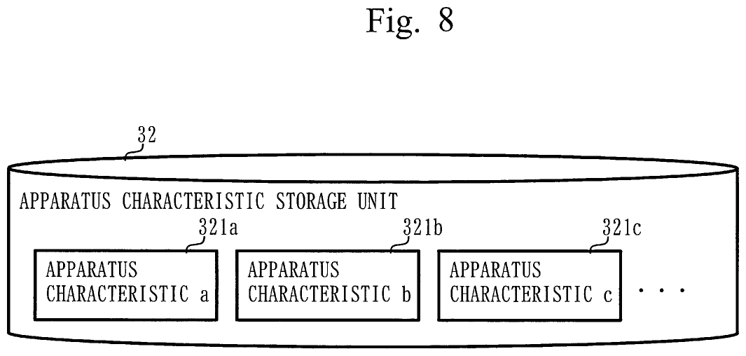

Description will be made on information to be stored in the apparatus characteristic storage unit 32 according to First Embodiment with reference to FIG. 8.

The apparatus characteristic storage unit 32 stores an apparatus characteristic 321 for each of a plurality of apparatuses 50. The apparatus 50 is a computer to perform image processing. The hardware configuration differs depending on the apparatus 50. For example, a CPU or the like mounted thereon differs depending on the apparatus 50.

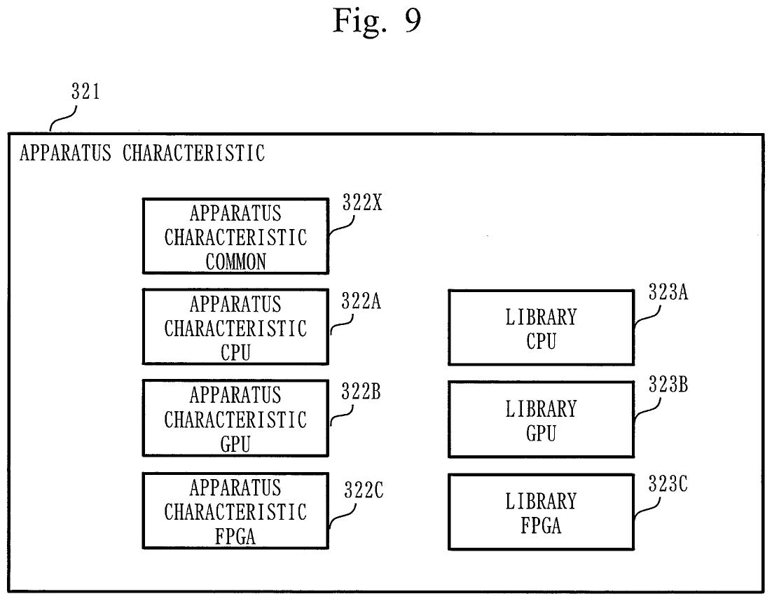

Description will be made on the apparatus characteristic 321 according to First Embodiment with reference to FIG. 9.

The apparatus characteristic 321 stores apparatus characteristic information 322 and a library 323 corresponding to the type of a processor included in the apparatus 50. The apparatus characteristic information 322 indicates a correction content with respect to a calculation formula indicated by the engine characteristic. The library 323 indicates a program, a function and the like provided by OSS, a hardware vendor or the like in order to efficiently use the CPU, the GPU and the FPGA included in the apparatus 50. OSS is an abbreviation for Open Source Software.

In FIG. 9, as the apparatus characteristic information 322, an apparatus characteristic common 322X common to the CPU, the GPU and the FPGA, an apparatus characteristic CPU 322A for CPU, an apparatus characteristic GPU 322B for GPU and an apparatus characteristic FPGA 322C for FPGA are indicated.

As the library 323, a library CPU 323A for CPU, a library GPU 323B for GPU and a library FPGA 323C for FPGA are indicated. For example, the CPU 323A for CPU corresponds to a BLAS being a program and a function to operate arithmetic operation on the CPU at a high speed. BLAS is an abbreviation for Basic Linear Algebra Subprograms.

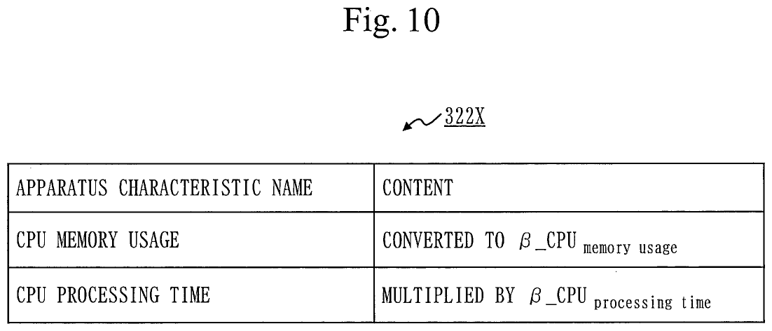

Description will be made on the apparatus characteristic information 322 according to First Embodiment with reference to FIG. 10 through FIG. 12.

FIG. 10 illustrates an example of the apparatus characteristic common 322X. In the apparatus characteristic common 322X, a content is set for each apparatus characteristic name. In FIG. 10, as the apparatus characteristic name, a CPU memory usage and a CPU processing time are set.

For the CPU memory usage, a correction content for the CPU memory usage is indicated. Specifically, in the CPU memory usage, it is indicated that α_CPU_{memory usage} is replaced with β_CPU_{memory usage}.

For the CPU processing time, a correction content with respect to the CPU processing time is indicated. Specifically, in the CPU processing time, it is indicated that the CPU processing time is multiplied by β_CPU_{processing time}.

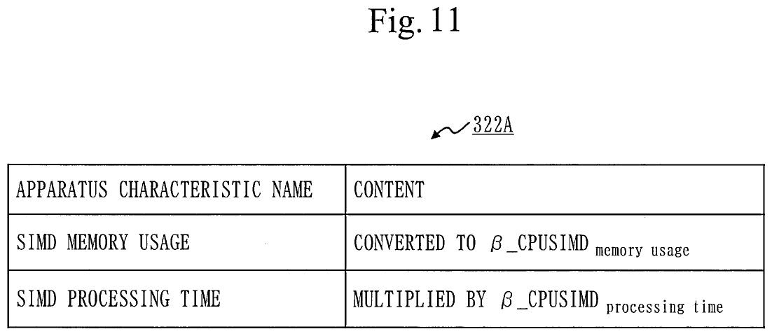

FIG. 11 illustrates an example of the apparatus characteristic CPU 322A. In the apparatus characteristic CPU 322A, a content is set for each apparatus characteristic name. In FIG. 11, as the apparatus characteristic name, an SIMD memory usage and an SIMD processing time are set. SIMD is an abbreviation for Single Instruction/Multiple Data.

For the SIMD memory usage, a correction content with respect to the CPU memory usage is indicated. Specifically, in the SIMD memory usage, it is indicated that α_CPU_{memory usage} is replaced with β_CPUSIMD_{memory usage}.

For the SIMD processing time, a correction content with respect to the CPU processing time is indicated. Specifically, in the SIMD processing time, it is indicated that the CPU processing time is multiplied by β_CPUSIMD_{processing time}.

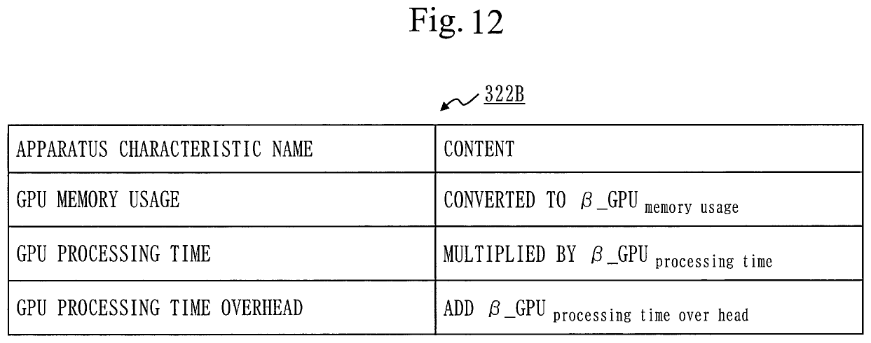

FIG. 12 illustrates an example of the apparatus characteristic GPU 322B. In the apparatus characteristic GPU 322B, a content is set for each apparatus characteristic name. In FIG. 12, as the apparatus characteristic name, a GPU memory usage, a GPU processing time and a GPU processing time overhead are set.

For the GPU memory usage, a correction content with respect to the GPU memory usage is indicated. Specifically, in the GPU memory usage, it is indicated that α_GPU_{memory usage} is replaced with β_GPU_{memory usage}.

For the GPU processing time, a correction content with respect to the GPU processing time is indicated. Specifically, in the GPU processing time, it is indicated that the GPU processing time is multiplied by β_GPU_{processing time}.

For the GPU processing time overhead, a correction content with respect to the CPU processing time is indicated. Specifically, in the GPU processing time overhead, it is indicated that β_GPU_{processing time} overhead is added to the CPU processing time. When processing using the GPU is performed, a communication preparation time is necessary between the CPU and the GPU. β_GPU_{processing time over head} is the communication preparation time.

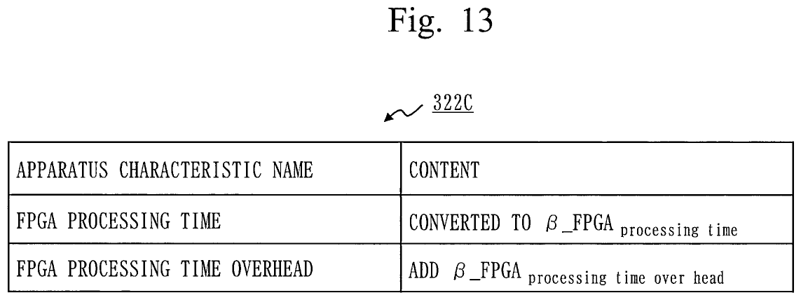

FIG. 13 illustrates an example of the apparatus characteristic FPGA 322C. In the apparatus characteristic FPGA 322C, a content is set for each apparatus characteristic name. In FIG. 13, as the apparatus characteristic name, an FPGA processing time and an FPGA processing time overhead are set.

For the FPGA processing time, a correction content with respect to the FPGA processing time is indicated. Specifically, in the FPGA processing time, it is indicated that the FPGA processing time is multiplied by β_FPGA_{processing time}.

For the FPGA processing time overhead, a correction content with respect to the CPU processing time is indicated. Specifically, in the FPGA processing time overhead, it is indicated that β_FPGA_{processing time over head} is added to the CPU processing time. When processing using the FPGA is performed, a communication preparation time is necessary between the CPU and the FPGA. β_FPGA_{processing time over head} is the communication preparation time.

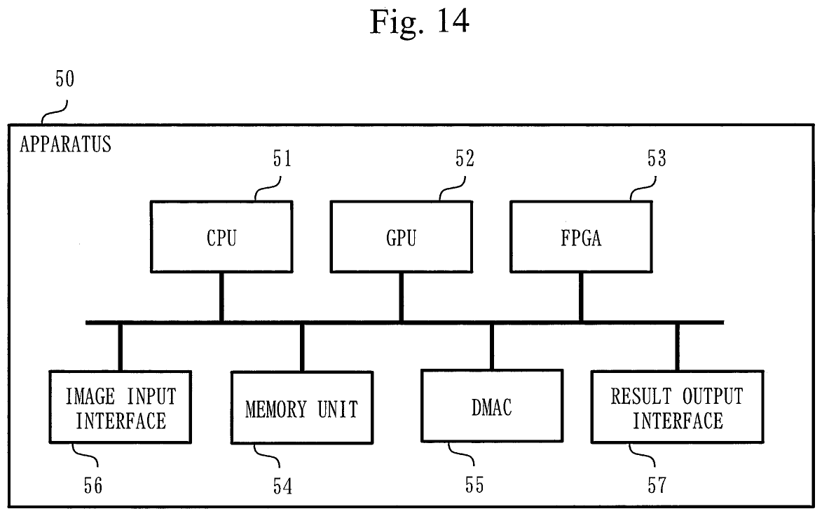

Description will be made on an example of the hardware configuration of the apparatus 50 according to First Embodiment with reference to FIG. 14 through FIG. 17.

FIG. 14 illustrates a configuration of the apparatus 50 including a CPU 51, a GPU 52 and an FPGA 53 as processors. The apparatus 50 includes a memory unit 54, a DMAC 55, an image input interface 56 and a result output interface 57 in addition to the CPU 51, the GPU 52 and the FPGA 53. DMAC is an abbreviation for Direct Memory Access Controller.

The memory unit 54 is a storage device to temporarily store data as with the memory unit 12. The memory 54 is, for example, an SRAM and a DRAM. The DMAC 55 is an IC to perform control over DMA transfer. The image input interface 56 is an interface to input an image. The result output interface 57 is an interface to output a processing result. The image input interface 56 and the result output interface 57 are, for example, USB ports.

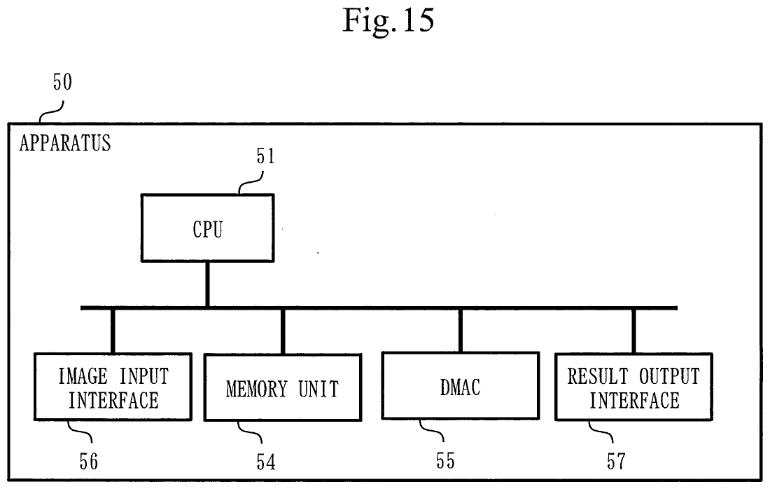

FIG. 15 illustrates a configuration of the apparatus 50 provided with only the CPU 51 as a processor. The apparatus 50 illustrated in FIG. 15 is the same as the apparatus 50 illustrated in FIG. 14 except that the apparatus 50 in FIG. 15 is not provided with the GPU 52 and the FPGA 53.

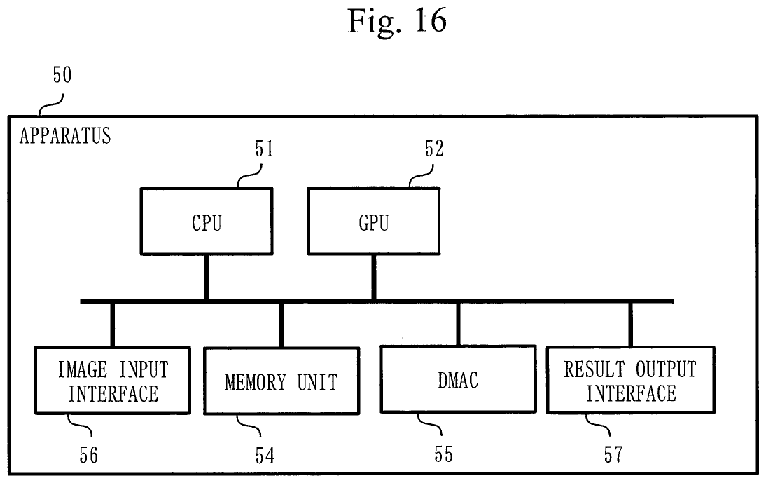

FIG. 16 illustrates a configuration of the apparatus 50 provided with only the CPU 51 and the GPU 52 as processors. The apparatus 50 illustrated in FIG. 16 is the same as the apparatus 50 illustrated in FIG. 14 except that the apparatus 50 in FIG. 16 is not provided with the FPGA 53.

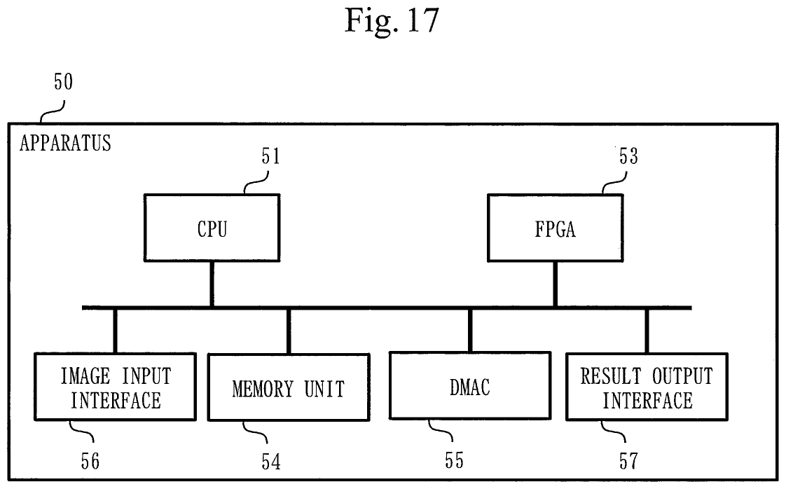

FIG. 17 illustrates a configuration of the apparatus 50 provided with only the CPU 51 and the FPGA 53 as processors. The apparatus 50 illustrated in FIG. 17 is the same as the apparatus 50 illustrated in FIG. 14 except that the apparatus 50 in FIG. 17 is not provided with the GPU 52.

The apparatus characteristic 321 described with reference to FIG. 9 is supposed to have a configuration including the CPU 51, the GPU 52 and the FPGA 53 as processors, as with the apparatus 50 illustrated in FIG. 14.

The apparatus characteristic 321 stores apparatus characteristic information 322 and a library 323 corresponding to the type of the processers. Therefore, in a case in which an apparatus 50 is provide with only the CPU 51 as the processor, as with the apparatus 50 illustrated in FIG. 15, for example, information for the GPU and the FPGA is unnecessary. Specifically, the apparatus characteristic GPU 322B for GPU, the apparatus characteristic FPGA 322C for FPGA, the library GPU 323B for GPU and the library FPGA 323C for FPGA are unnecessary.

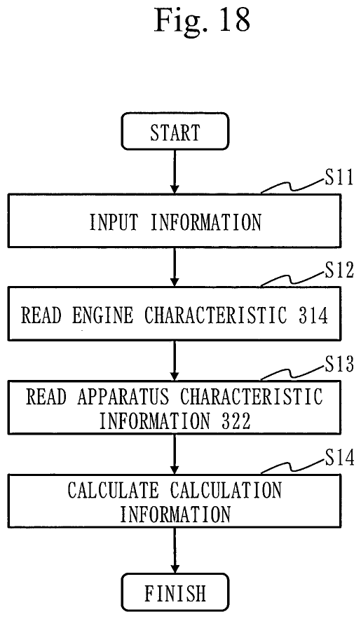

Description will be made on a flow of the processing of the image processing support device 10 according to First Embodiment with reference to FIG. 18.

### (Step S11: Information Input Processing)

The calculation unit 21 accepts input of designation of image processing of a processing target, designation of the apparatus 50 to operate the image processing, and information with respect to image data being the processing target.

Specifically, the calculation unit 21 makes the image processing of the processing target be designated by causing a user to operate the input device 15.

Similarly, the calculation unit 21 makes the apparatus 50 to operate the image processing be designated by causing the user to manipulate the input device 15. Similarly, the calculation unit 21 makes the information with respect to the image data being the processing target be input by causing the user to manipulate the input device 15.

The information on the image data being the processing target is supposed to include a width W, a height H and the number of bits D per pixel of the image data being the processing target. Hereinafter, the image processing designated is called designated processing. Further, the apparatus 50 designated is called a designated apparatus.

### (Step S12: Engine Characteristic Acquisition Processing)

The engine characteristic acquisition unit 22 reads out an engine characteristic 314 included in an image processing module 311 with respect to the designated processing from the module storage unit 31.

### (Step S13: Apparatus Characteristic Acquisition Processing)

The apparatus characteristic acquisition unit 23 reads out apparatus characteristic information 322 included in the apparatus characteristic 321 with respect to the designated apparatus from the apparatus characteristic storage unit 32.

### (Step S14: Calculation Processing)

The calculation unit 21 calculates calculation information in a case of performing the designated processing by the designated apparatus.

In this case, the calculation unit 21 sets each of one or more engines that can be used in the designated processing, and that can be used by the designated apparatus as an engine being a calculation target. Then, the calculation unit 21 calculates the calculation information based on the engine characteristic 314 and the apparatus characteristic information 322 with respect to the engine being the calculation target. The calculation unit 21 displays the calculation information calculated on the display device 16.

As a concrete example, the image processing module 311 with respect to the designated processing is supposed to be the image processing module 311 illustrated in FIG. 3. Further, the apparatus characteristic 321 with respect to the designated apparatus is supposed to be the apparatus characteristic 321 illustrated in FIG. 9.

In this case, the image processing module 311 includes the CPU 312A, the engine GPU 312B and the engine FPGA 312C as the engine 312. That is, in the designated processing, it is possible to use the engine CPU 312A, the engine GPU 312B and the engine FPGA 312C. Further, the apparatus characteristic 321 includes the apparatus characteristic CPU 322A, the apparatus characteristic GPU 322B and the apparatus characteristic FPGA 322C. That is, the designated apparatus includes processors of the CPU 51, the GPU 52 and the FPGA 53. The apparatus 50 is supposed to be capable of using the engines corresponding to the processors included in the apparatus 50. Therefore, the designated apparatus is capable of using the engine CPU 312A, the engine GPU 312B and the engine FPGA 312C.

Therefore, the calculation unit 21 sets each of the engine CPU 312A, the engine GPU 312B and the engine FPGA 312C as the engine being the calculation target.

For example, the designated apparatus is supposed to be equipped with only the CPU 51 and the GPU 52, and be not equipped with the FPGA 53, as the processors. In this case, the apparatus 50 is capable of using the engine CPU 312A and the engine GPU 312B, and is not capable of using the engine FPGA 312C.

Therefore, the calculation unit 21 sets each of the engine CPU 312A and the engine GPU 312B as the engine being the calculation target.

Description will be made concretely on a calculation method of the calculation information.

Description will be made on calculation of a used memory amount.

The engine CPU 312A is supposed to be the engine being the calculation target. In this case, the calculation unit 21 calculates the used memory amount using the calculation formula of the CPU memory usage in FIG. 5. At this time, the calculation unit 21 substitutes the width W, the height H and the number of bits D per pixel of the image data being the processing target input in Step S11 in the calculation formula. It is supposed that the width W is 640, the height H is 480 and the number of bits D per pixel is 8 bits (grayscale with 8-bit color depth). Then, the used memory amount is α_CPU_{memory usage}+(640+2)×(480+3+1)×(8/8).

As described above, α_CPU_{memory usage} is a basic used memory amount by the CPU, and is mathematized. By entering the width W, the height H, the number of bits D per pixel of the image data being the processing target and the like in the formula of α_CPU_{memory usage} as well, the used memory amount in a case of performing the designated processing by a general apparatus 50 is calculated.

The calculation unit 21 refers to the apparatus characteristic information 322 of the designated apparatus, and corrects the used memory amount. Description will be made on the assumption that SIMD is not performed. The calculation unit 21 refers to the correction content with respect to the used memory amount in FIG. 10. Then, the calculation unit 21 replaces α_CPU_{memory usage} with β_CPU_{memory usage}. That is, the calculation unit 21 calculates β_CPU_{memory usage}+(640+2)×(480+3+1)×(8/8) instead of α_CPU_{memory usage}+(640+2)/(480+3+1)×(8/8).

β_CPU_{memory usage} is also mathematized. Then, by entering the width W, the height H, the number of bits D per pixel of the image data being the processing target and the like in the formula of β_CPU_{memory usage} as well, the used memory amount in the case of performing the designated processing by the designated apparatus is calculated.

When SIMD is performed, β_SIMD_{memory usage} in FIG. 11 is used instead of β_CPU_{memory usage}.

When the engine GPU 312B is the engine being the calculation target, the calculation unit 21 calculates the used memory amount by using the calculation formula of the CPU memory usage in FIG. 6 and the calculation formula of the GPU memory usage in FIG. 6. The sum of the used memory amount obtained by the calculation formula of the CPU memory usage, and the used memory amount obtained by the calculation formula of the GPU memory usage is the used memory amount in the case in which the engine GPU 312B is the engine being the calculation target.

The calculation method of the CPU memory usage is the same as the case in which the engine CPU 312A is the engine being the calculation target. The calculation method of the GPU memory usage is mostly similar to the calculation method of the CPU memory usage. That is, the calculation unit 21 substitutes the width W, the height H and the number of bits D per pixel of the image data being the processing target in the calculation formula. Then, the calculation unit 21 refers to the apparatus characteristic information 322 of the designated apparatus, and calculates the formula of β_GPU_{memory usage} by replacing α_GPU_{memory usage} with β_GPU_{memory usage}.

When the engine FPGA 312C is the engine being the calculation target, the calculation unit 21 calculates the used memory amount using the calculation formula of the CPU memory usage in FIG. 7. The calculation method of the CPU memory usage is the same as the case in which the engine CPU 312A is the engine being the calculation target.

Description will be made on calculation of the processing time.

The engine CPU 312A is supposed to be the engine being the calculation target. In this case, the calculation unit 21 calculates the processing time using the calculation formula of the CPU processing time in FIG. 5. At this time, the calculation unit 21 substitutes the width W, the height H and the number of bits D per pixel of the image data of processing target input in Step S11 in the calculation formula. It is assumed that the width W is 640, the height H is 480 and the number of bits D per pixel is 8 bits (grayscale with 8-bit color depth). Then, the processing time is α_CPU_{processing time}+(640+2)×(480+3+1)×(8/8).

As described above, α_CPU_{processing time} is a CPU processing time which is fixed for an engine, and mathematized. By entering the width W, the height H, the number of bits D per pixel of the image data being the processing target and the like in the formula of α_CPU_{processing time}, the processing time in the case of performing the designated processing by the general apparatus 50 is calculated.

The calculation unit 21 refers to the apparatus characteristic information 322 of the designated apparatus, and corrects the processing time. Description will be made on the assumption that SIMD is not performed. The calculation unit 21 refers to the correction content with respect to the memory processing time in FIG. 10. Then, the calculation unit 21 multiplies also the processing time in the case of performing the designated processing by the general apparatus 50 by β_CPU_{processing time}. β_CPU_{processing time} is also mathematized. By entering the width W, the height H, the number of bits D per pixel of the image data being the processing target and the like in the formula of β_CPU_{processing time} as well, the processing time in the case of performing the designated processing by the designated apparatus is calculated.

When SIMD is performed, β_SIMD_{processing time} in FIG. 11 is used instead of β_CPU_{processing time}.

When the engine GPU 312B is the engine being the calculation target, the calculation unit 21 calculates the processing time by using the calculation formula of the CPU processing time in FIG. 6 and the calculation formula of the GPU processing time in FIG. 6. Herein, the CPU processing time and the GPU processing time are calculated separately.

The calculation method of the CPU processing time is mostly the same as the case in which the engine CPU 312A is the engine being the calculation target. The calculation method of the CPU processing time differs in that β_CPU_{processing time over head} is added to the processing time calculated in the case in which the engine CPU 312A is the engine being the calculation target.

The calculation method of the GPU processing time is mostly similar to the calculation method of the CPU processing time. That is, the calculation unit 21 substitutes the width W, the height H and the number of bits D per pixel of the image data of processing target in the calculation formula. Then, the calculation unit 21 refers to the apparatus characteristic information 322 of the designated apparatus, and multiplies the processing time calculated by β_GPU_{processing time}.

When the engine FPGA 312C is the engine being the calculation target, the calculation unit 21 calculates the processing time using the calculation formula of the CPU processing time in FIG. 7 and the calculation formula of the FPGA processing time in FIG. 7. Herein, the CPU processing time and the FPGA processing time are calculated separately.

The calculation method of the CPU processing time is mostly the same as the case in which the engine CPU 312A is the engine being the calculation target. The calculation method of the CPU processing time differs in that β_FPGA_{processing time} overhead is added to the processing time calculated in the case in which the engine CPU 312A is the engine being the calculation target.

The calculation method of the FPGA processing time is mostly similar to the calculation method of the CPU processing time. That is, the calculation unit 21 substitutes the width W, the height H and the number of bits D per pixel of the image data being the processing target in the calculation formula. Then, the calculation unit 21 refers to the apparatus characteristic information 322 of the designated apparatus, and multiplies the processing time calculated by β_FPGA_{processing time}.

### ***Effect of First Embodiment***

As described above, the image processing support device 10 according to First Embodiment calculates the calculation information based on the engine characteristic and the apparatus characteristic with respect to the engine being the calculation target. The calculation information is at least either of the used memory amount and the processing time. In this manner, it is possible to calculate at least either of the used memory amount and the processing time flexibly corresponding to various types of image processing desired by a user without managing a large amount of information.

The user is capable of recognizing at least either of the used memory amount and the processing time in the case of performing the designated processing by the designated apparatus. In this manner, it is easy to consider how to combine a plurality of sets of image processing and to realize integration processing. Further, it becomes easier to select the apparatus 50 to perform the integration processing.

### ***Other Configurations***

### <First Variation>

In Step S11 of FIG. 18, two or more sets of image processing may be designated as the designated processing. In this case, the calculation unit 21 calculates calculation information for each of the two or more sets of designated processing.

### <Second Variation>

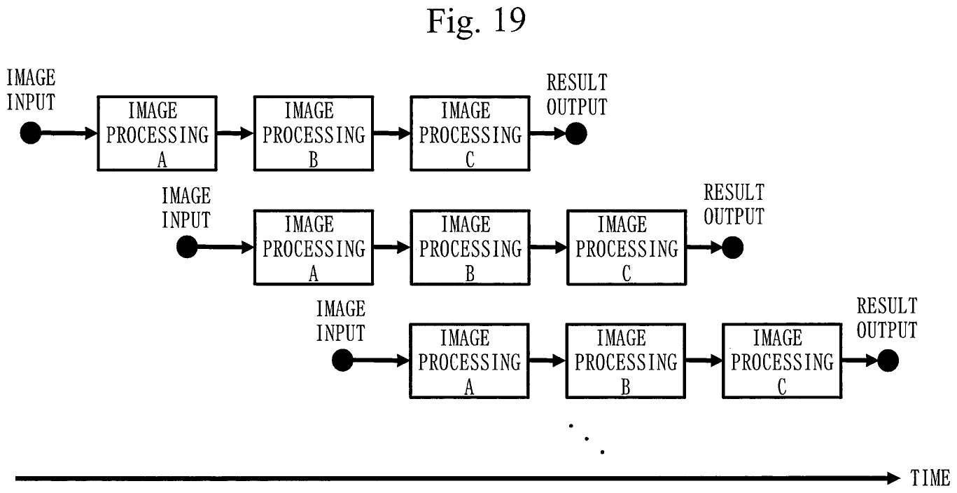

In Step S11 of FIG. 18, an execution order of the designated processing may be designated, as illustrated in FIG. 19. In this case, the execution order may be designated so that a part of the designated processing is executed in parallel.

FIG. 19 illustrates that image processing A, image processing B and image processing C are performed in order by using the image data as input, and the result is output. FIG. 19 illustrates that this series of processing is repeatedly performed. Then, when the image processing B is performed in the n-th processing, the n+1-th image processing A is performed in parallel. Further, when the image processing C is performed in the n′-th processing, the n′+1-th image processing B is performed in parallel.

In this case, it is supposed that the CPU is used in any of the image processing A, the image processing B and the image processing C. Then, there may be a case in which three sets of image processing are performed in parallel by using the CPU. When the CPU performs a plurality of sets of processing in parallel, it is impossible for the CPU to exhibit the same performance as in the case of performing only one processing. Therefore, in this case, the calculation unit 21 corrects the processing time. At this time, the calculation unit 21 adds a correction corresponding to the number of parallels. As a concrete example, the calculation unit 21 multiplies the processing time calculated by a value 7 corresponding to the number of parallels. The value 7 is a value corresponding to an overhead such as context switching of the OS occurred in the parallel processing, and the like.

### <Third Variation>

In First Embodiment, each functional component is realized by software. However, each functional component may be realized by hardware, as Third Variation. With respect to Third Variation, description will be made on parts different from First Embodiment.

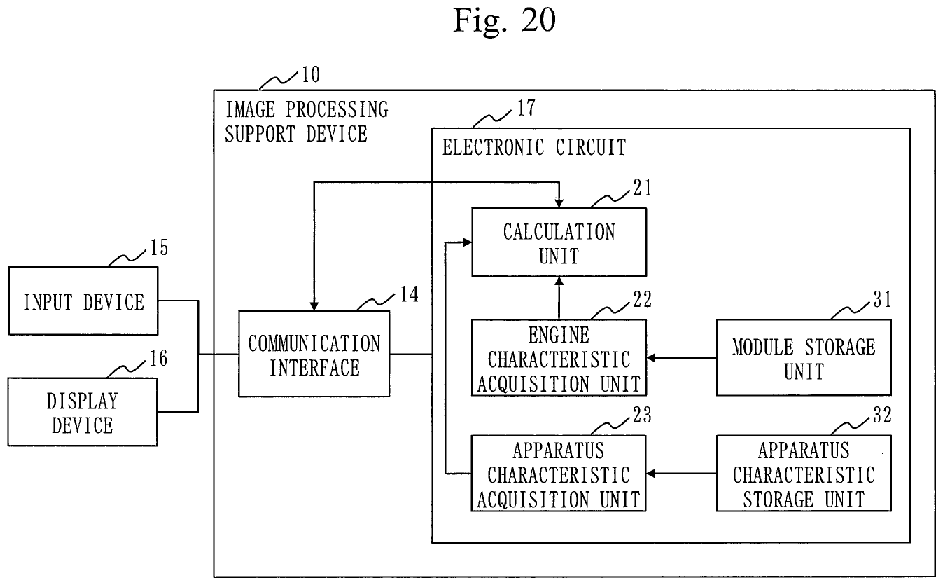

Description will be made on a configuration of the image processing support device 10 according to Third Variation with reference to FIG. 20.

When each functional component is realized by a hardware component, the image processing support device 10 is equipped with an electronic circuit 17 instead of the processor 11, the memory unit 12 and the storage unit 13. The electronic circuit 17 is a dedicated circuit to realize each functional component, and the functions of the memory unit 12 and the storage unit 13.

As the electronic circuit 17, a single circuit, a composite circuit, a programmed processor, a parallel-programmed processor, a logic IC, a GA, an ASIC or an FPGA is supposed. GA is an abbreviation for “Gate Array”. ASIC is an abbreviation for “Application Specific Integrated Circuit”.

Each functional component may be realized by one electronic circuit 17, or may be dispersedly realized by a plurality of electronic circuits 17.

### <Fourth Variation>

As fourth variation, a part of each functional component may be realized by a hardware component, and another part of each functional component may be realized by software.

The processor 11, the memory unit 12, the storage unit 13 and the electronic circuit 17 are called processing circuitry. That is, the functions of each functional component are realized by the processing circuitry.

Further, “unit” in the description above may be replaced with “circuit”, “step”, “procedure”, “process” or “processing circuitry”.

### Second Embodiment

Second Embodiment is different from First Embodiment in that an engine of which the calculation information satisfies a limiting value is specified. In Second Embodiment, this different part will be described, and description for the same part will be omitted.

### ***Description of Operation***

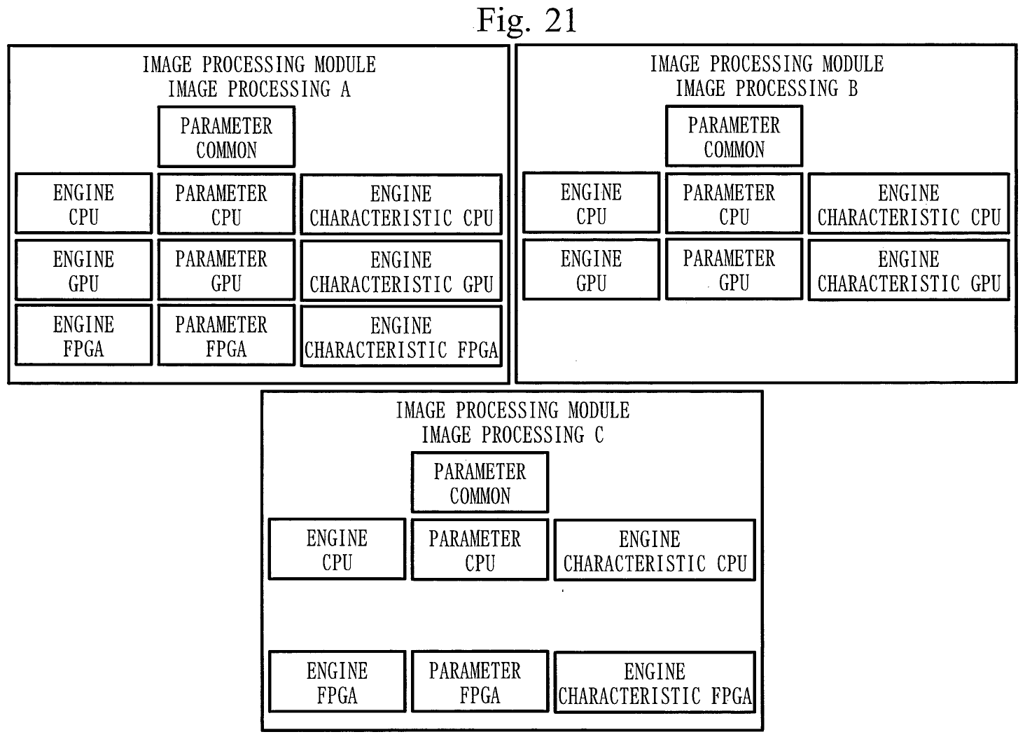

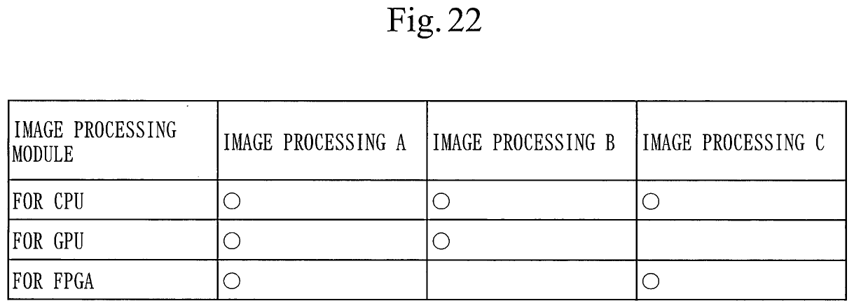

Description will be made on an operation of the image processing support device 10 according to Second Embodiment with reference to FIG. 19, FIG. 21 and FIG. 22.

As illustrated in FIG. 21, the image processing module 311 with respect to the image processing Ain FIG. 19 includes the information for CPU, the information for GPU and the information for FPGA. The image processing module 311 with respect to the image processing B in FIG. 19 includes the information for CPU and the information for GPU. The image processing module 311 with respect to the image processing C in FIG. 19 includes the information for CPU and the information for FPGA.

The relation between each image processing and a processor to perform each image processing is as illustrated in FIG. 22. In this case, there are 12 patterns of processors to perform each image processing: three types with respect to the image processing A×two types with respect to the image processing B×two types with respect to the image processing C.

The calculation unit 21 calculates the used memory amount and the processing time for each pattern. Then, the calculation unit 21 specifies patterns that satisfy the limiting value.

For example, it is assumed that the processing time of equal to or smaller than X [ms (milliseconds)] is given as the limiting value. In this case, the calculation unit 21 extracts all patterns in which the processing time is equal to or smaller than X [ms]. Then, the calculation unit 21 displays information to indicate the patterns extracted on the display device 16.

### ***Effect of Second Embodiment***

As described above, the image processing support device 10 according to Second Embodiment specifies the engine of which the calculation information satisfies the limiting value. In this manner, it is possible for the user to easily specify the engine that satisfies a condition expected.

### ***Other Configurations***

### <Fifth Variation>

The calculation unit 21 may generate and output an execution module being software to realize integration processing to combine engines to perform image processing with respect to the pattern extracted. Further, the calculation unit 21 may output not only the engines but also a library 323 included in the apparatus characteristic 321 related to the engines.

### <Sixth Variation>

In Second Embodiment, the engine of which the calculation information satisfies the limiting value is specified. However, the calculation unit 21 may specify an engine with the best calculation information. The best calculation information means that the used memory amount is smallest, or the processing time is shortest. Otherwise, it may be possible to decide whether the calculation information is best based on an evaluation value obtained by combining the used memory amount and the processing time. For example, it may be possible to suppose that the best calculation information means that the evaluation value obtained by applying weighted addition to the used memory amount and the processing time is smallest.

In this case, it is unnecessary to set the limiting value as in Second Embodiment.

In the above, description has been made on the embodiments and the variations of the present disclosure. Some of these embodiments and variations may be combined and performed. Otherwise, any one or some may be partially performed. The present disclosure is not limited to the embodiments and the variations above, and various modifications can be added as needed.

### REFERENCE SIGNS LIST

10: image processing support device; 11: processor; 12: memory unit; 13: storage unit; 14: communication interface; 15: input device; 16: display device; 17: electronic circuit; 21: calculation unit; 22: engine characteristic acquisition unit; 23: apparatus characteristic acquisition unit; 31: module storage unit; 311: image processing module; 312: engine; 312A: engine CPU; 312B: engine GPU; 312C: engine FPGA; 313: parameter; 313X: parameter common; 313A: parameter CPU; 313B: parameter GPU; 313C: parameter FPGA; 314: engine characteristic; 314A: engine characteristic CPU; 314B: engine characteristic GPU; 314C: engine characteristic FPGA; 32: apparatus characteristic storage unit; 321: apparatus characteristic; 322: apparatus characteristic information; 322X: apparatus characteristic common; 322A: apparatus characteristic CPU; 322B: apparatus characteristic GPU; 322C: apparatus characteristic FPGA; 323: library; 323A: library CPU; 323B: library GPU; 323C: library FPGA; 50: apparatus

1. An image processing support device comprising:
processing circuitry
to acquire, by taking each of a plurality of image processes as a target image process, an engine characteristic indicating a calculation formula to calculate calculation information being at least either of a used memory amount and a processing time in a case in which the target image process is performed with respect to each of one or more engines that can be used in the target image process among one or more engines corresponding to each of a plurality of types of processors, the calculation formula using information on image data being a processing target as an input;
to acquire, by taking each of a plurality of apparatuses as a target apparatus, apparatus characteristic information indicating a correction content for the calculation formula indicated by the engine characteristic with respect to one or more types of processors that are included in the target apparatus among the plurality of types of processors, and
to calculate the calculation information in a case in which a designated process being an image process designated among the plurality of image processes is performed by a designated apparatus being an apparatus designated among the plurality of apparatuses, by taking each of one or more engines that can be used in the designated process, and corresponds to a processor included in the designated apparatus as an engine being a calculation target, based on the engine characteristic and the apparatus characteristic information with respect to the engine being the calculation target.

2. The image processing support device as defined in claim 1, wherein the processing circuitry applies the correction content indicated by the apparatus characteristic information to the calculation formula indicated by the engine characteristic, and calculates the calculation information.

3. The image processing support device as defined in claim 2, wherein the processing circuitry enters the information on the image data being the processing target in the calculation formula to which the correction content is applied, and calculates the calculation information.

4. The image processing support device as defined in claim 1, wherein the processing circuitry calculates the calculation information with respect to each of two or more designated processes in a case in which two or more image processes are designated as the designated process.

5. The image processing support device as defined in claim 1, wherein the processing circuitry adds, in a case in which the processing time is calculated as the calculation information, and the designated process is performed in parallel for the number of parallels, a correction corresponding to the number of parallels to the processing time calculated.

6. The image processing support device as defined in claim 1, wherein the processing circuitry specifies an engine of which the calculation information calculated satisfies a limiting value, with respect to the designated process.

7. The image processing support device as defined in claim 1, wherein the processing circuitry specifies an engine of which the calculation information calculated is best, with respect to the designated process.

8. The image processing support device as defined in claim 6, wherein the processing circuitry generates an execution module to cause the engine specified to perform the designated process.

9. An image processing support method comprising:
by a computer, acquiring, by taking each of a plurality of image processes as a target image process, an engine characteristic indicating a calculation formula to calculate calculation information being at least either of a used memory amount and a processing time in a case in which the target image process is performed with respect to each of one or more engines that can be used in the target image process among one or more engines corresponding to each of a plurality of types of processors, the calculation formula using information on image data being a processing target as an input;
by the computer, acquiring, by taking each of a plurality of apparatuses as a target apparatus, apparatus characteristic information indicating a correction content for the calculation formula indicated by the engine characteristic with respect to one or more types of processors that are included in the target apparatus among the plurality of types of processors, and
by the computer, calculating the calculation information in a case in which a designated process being an image process designated among the plurality of image processes is performed by a designated apparatus being an apparatus designated among the plurality of apparatuses, by taking each of one or more engines that can be used in the designated process, and corresponds to a processor included in the designated apparatus as an engine being a calculation target, based on the engine characteristic and the apparatus characteristic information with respect to the engine being the calculation target.

10. A non-transitory computer readable medium storing an image processing support program to cause a computer to function as an image processing support device to perform:
an engine characteristic acquisition process to acquire, by taking each of a plurality of image processes as a target image process, an engine characteristic indicating a calculation formula to calculate calculation information being at least either of a used memory amount and a processing time in a case in which the target image process is performed with respect to each of one or more engines that can be used in the target image process among one or more engines corresponding to each of a plurality of types of processors, the calculation formula using information on image data being a processing target as an input;
an apparatus characteristic acquisition process to acquire, by taking each of a plurality of apparatuses as a target apparatus, apparatus characteristic information indicating a correction content for the calculation formula indicated by the engine characteristic with respect to one or more types of processors that are included in the target apparatus among the plurality of types of processors, and
a calculation process to calculate the calculation information in a case in which a designated process being an image process designated among the plurality of image processes is performed by a designated apparatus being an apparatus designated among the plurality of apparatuses, by taking each of one or more engines that can be used in the designated process, and corresponds to a processor included in the designated apparatus as an engine being a calculation target, based on the engine characteristic and the apparatus characteristic information with respect to the engine being the calculation target.
